(19) United States
(12) Patent Application Publication
(10) Pub. No.: US 2026/0032159 A1
(43) Pub. Date: Jan. 29, 2026

(54) TECHNIQUES FOR IN-APP COMMUNICATION SESSION SCHEDULING

(71) Applicant: WhatsApp, LLC, Menlo Park, CA (US)

(72) Inventor: Prasanth Guruprasad, Fremont, CA (US)

(21) Appl. No.: 18/787,642

(22) Filed: Jul. 29, 2024

(51) Int. Cl. H04L 65/1069; G06F 3/04883; G06Q 10/1093

(52) U.S. Cl. CPC H04L 65/1069; G06F 3/04883; G06Q 10/1093

(57) ABSTRACT

A method includes receiving a user input corresponding to a graphical user interface element associated with the messaging thread, generating and storing a communication session trigger based on the user input, updating the messaging thread to display a visual indicator corresponding to the communication session trigger, receiving one or more events, determining that an event of the one or more events satisfies the communication session trigger, and initiating a communication session between the first user device and the second user device via the messaging application.

### TECHNOLOGICAL FIELD

Examples of the present disclosure generally relate to methods, devices, and computer program products for scheduling communication sessions (e.g., audio, video, and/or metaverse sessions) in a messaging application.

### BACKGROUND

In the current landscape of digital communication, users frequently encounter challenges when coordinating communication sessions (e.g., calls), for example, across different time zones and between busy schedules. Existing messaging applications (also referred to as “apps”) may allow for instantaneous voice and video calls but lack the functionality to schedule calls in advance within the app. This limitation forces users to resort to external solutions, such as calendar applications, reminder apps, or even physical notes, to manage their future call commitments. This fragmentation not only disrupts the user experience but also increases the risk of missed or conflicting appointments, especially in professional and personal contexts where timeliness matters.

The introduction of a call scheduling feature directly within the messaging app addresses this gap, providing a seamless and integrated solution for users. By allowing users to schedule calls ahead of time (e.g., with automatic time zone adjustments and reminders), the app may enhance communication efficiency and reliability. The feature may streamline the call scheduling process, reducing dependency on third-party tools and helping users manage their communication needs more effectively within a single platform. The ability to schedule calls within the messaging app does not only improve user convenience but also fosters better time management and adherence to planned interactions, ultimately enhancing overall user satisfaction and engagement.

### BRIEF SUMMARY

The subject technology is directed to a messaging application configured to enable in-app call scheduling. Additional advantages will be set forth in part in the description that follows or may be learned by practice. The advantages will be realized and attained by means of the elements and combinations particularly pointed out in the appended claims. It is to be understood that both the foregoing general description and the following detailed description are exemplary and explanatory only and are not restrictive, as claimed.

### BRIEF DESCRIPTION OF THE DRAWINGS

The summary, as well as the following detailed description, is further understood when read in conjunction with the appended drawings. For the purpose of illustrating the disclosed subject matter, examples of the disclosed subject matter are shown in the drawings; however, the disclosed subject matter is not limited to the specific methods, compositions, and devices disclosed. In addition, the drawings are not necessarily drawn to scale. In the drawings:

FIG. 1 illustrates a diagram of an exemplary network environment, in accordance with one or more example aspects of the subject technology.

FIG. 2 illustrates a diagram of an exemplary communication device, in accordance with one or more example aspects of the subject technology.

FIG. 3 illustrates an exemplary computing system, in accordance with one or more example aspects of the subject technology.

FIG. 4 illustrates a machine learning and training model framework, in accordance with example aspects of the present disclosure.

FIG. 5 illustrates an example process for call scheduling between two client devices, in accordance with one or more example aspects of the subject technology.

FIG. 6 illustrates an example process for call scheduling between two client devices facilitated by a server device, in accordance with one or more example aspects of the subject technology.

FIG. 7 illustrates a flow diagram of an example process for communication session scheduling between two client devices, in accordance with one or more example aspects of the subject technology.

The figures depict various examples for purposes of illustration only. One skilled in the art will readily recognize from the following discussion that alternative examples of the structures and methods illustrated herein may be employed without departing from the principles described herein.

### DETAILED DESCRIPTION

Some examples of the subject technology will now be described more fully hereinafter with reference to the accompanying drawings, in which some, but not all examples of the subject technology are shown. Indeed, various examples of the subject technology may be embodied in many different forms and should not be construed as limited to the examples set forth herein. Like reference numerals refer to like elements throughout.

As used herein, the terms “data,” “content,” “information,” and similar terms may be used interchangeably to refer to data capable of being transmitted, received and/or stored in accordance with examples of the disclosure. Moreover, the term “exemplary,” as used herein, is not provided to convey any qualitative assessment, but instead merely to convey an illustration of an example. Thus, use of any such terms should not be taken to limit the spirit and scope of examples of the disclosure.

As defined herein, a “computer-readable storage medium,” which refers to a non-transitory, physical or tangible storage medium (e.g., volatile or non-volatile memory device), may be differentiated from a “computer-readable transmission medium,” which refers to an electromagnetic signal.

As referred to herein, an “application” or “app” may refer to a computer software package that may perform specific functions for users and/or, in some cases, for another application(s). An application(s) may utilize an operating system (OS) and other supporting programs to function. In some examples, an application(s) may request one or more services from, and communicate with, other entities via an application programming interface (API).

As referred to herein, a metaverse may denote an immersive virtual space or world in which devices may be utilized in a network in which there may, but need not, be one or more social connections among users in the network or with an environment in the virtual space or world. A Metaverse or Metaverse network may be associated with three-dimensional (3D) virtual worlds, online games (e.g., video games), one or more content items such as, for example, images, videos, non-fungible tokens (NFTs) and in which the content items may, for example, be purchased with digital currencies (e.g., cryptocurrencies) and other suitable currencies. In some examples, a Metaverse or Metaverse network may enable the generation and provision of immersive virtual spaces in which remote users may socialize, collaborate, learn, shop and/or engage in various other activities within the virtual spaces, including through the use of augmented/virtual/mixed reality.

As referred to herein, a resource(s), or an external resource(s) may refer to any entity or source that may be accessed by a program or system that may be running, executed or implemented on a communication device and/or a network. Some examples of resources may include, but are not limited to, HyperText Markup Language (HTML) pages, web pages, images, videos, scripts, stylesheets, other types of files (e.g., multimedia files) that may be accessible via a network (e.g., the Internet) as well as other files that may be locally stored and/or accessed by communication devices.

It is to be understood that the methods and systems described herein are not limited to specific methods, specific components, or to particular implementations. It is also to be understood that the terminology used herein is for the purpose of describing particular embodiments only and is not intended to be limiting.

### Exemplary System Architecture

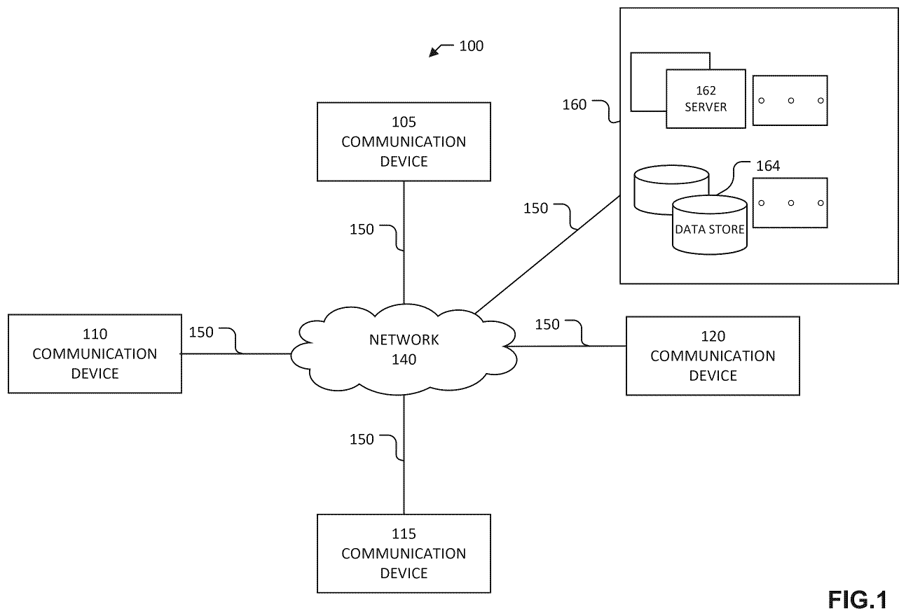

Reference is now made to FIG. 1, which is a block diagram of a system according to exemplary embodiments. As shown in FIG. 1, the system 100 may include one or more communication devices 105, 110, 115 and 120 and a network device 160. Additionally, the system 100 may include any suitable network such as, for example, network 140. In some examples, the network 140 may be any suitable network capable of provisioning content and/or facilitating communications among entities within, or associated with the network 140. As an example and not by way of limitation, one or more portions of network 140 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. Network 140 may include one or more networks 140.

Links 150 may connect the communication devices 105, 110, 115 and 120 to network 140, network device 160 and/or to each other. This disclosure contemplates any suitable links 150. In some exemplary embodiments, one or more links 150 may include one or more wired and/or wireless links, such as, for example, Digital Subscriber Line (DSL) or Data Over Cable Service Interface Specification (DOCSIS)), wireless (such as for example Wi-Fi or Worldwide Interoperability for Microwave Access (WiMAX)), or optical (such as for example Synchronous Optical Network (SONET) or Synchronous Digital Hierarchy (SDH). In some exemplary embodiments, one or more links 150 may each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link 150, or a combination of two or more such links 150. Links 150 need not necessarily be the same throughout system 100. One or more first links 150 may differ in one or more respects from one or more second links 150.

In some exemplary embodiments, communication devices 105, 110, 115, 120 may be electronic devices including hardware, software, or embedded logic components or a combination of two or more such components and capable of carrying out the appropriate functionalities implemented or supported by the communication devices 105, 110, 115, 120. As an example, and not by way of limitation, the communication devices 105, 110, 115, 120 may be a computer system such as, for example, a desktop computer, notebook or laptop computer, netbook, a tablet computer (e.g., a smart tablet), e-book reader, Global Positioning System (GPS) device, camera, personal digital assistant (PDA), handheld electronic device, cellular telephone, smartphone, smart glasses, augmented/virtual reality device, smart watches, charging case, or any other suitable electronic device, or any suitable combination thereof. The communication devices 105, 110, 115, 120 may enable one or more users to access network 140. The communication devices 105, 110, 115, 120 may enable a user(s) to communicate with other users at other communication devices 105, 110, 115, 120. For example, communication devices 105, 110, 115, 120 may be participating in a messaging thread involving the exchange of messages created by respective user input.

Network device 160 may be accessed by the other components of system 100 either directly or indirectly (e.g., via network 140). As an example and not by way of limitation, communication devices 105, 110, 115, 120 may access network device 160 using a web browser or a native application associated with network device 160 (e.g., a mobile social-networking application, a messaging application, another suitable application, or any combination thereof) either directly or via network 140.

In particular exemplary embodiments, network device 160 may include one or more servers 162. Each server 162 may be a unitary server or a distributed server spanning multiple computers or multiple data centers. Servers 162 may be of various types, such as, for example and without limitation, web server, news server, mail server, message server, advertising server, file server, application server, exchange server, database server, proxy server, another server suitable for performing functions or processes described herein, or any combination thereof. In particular exemplary embodiments, each server 162 may include hardware, software, or embedded logic components or a combination of two or more such components for carrying out the appropriate functionalities implemented and/or supported by server 162.

In particular exemplary embodiments, network device 160 may include one or more data stores 164. Data stores 164 may be used to store various types of information. In particular exemplary embodiments, the information stored in data stores 164 may be organized according to specific data structures. In particular exemplary embodiments, each data store 164 may be a relational, columnar, correlation, or other suitable database. Although this disclosure describes or illustrates particular types of databases, this disclosure contemplates any suitable types of databases. Particular exemplary embodiments may provide interfaces that enable communication devices 105, 110, 115, 120 and/or another system (e.g., a third-party system) to manage, retrieve, modify, add, or delete, the information stored in data store 164. For example, a server 162 may facilitate a messaging thread and/or calls between the communication devices 105, 110, 115, 120.

Network device 160 may provide users of the system 100 the ability to communicate and interact with other users. In particular exemplary embodiments, network device 160 may provide users with the ability to take actions on various types of items or objects, supported by network device 160. In particular exemplary embodiments, network device 160 may be capable of linking a variety of entities. As an example and not by way of limitation, network device 160 may enable users to interact with each other as well as receive content from other systems (e.g., third-party systems) or other entities, or allow users to interact with these entities through an application programming interface (API) or other communication channels.

It should be pointed out that although FIG. 1 shows one network device 160 and four communication devices 105, 110, 115 and 120, any suitable number of network devices 160 and communication devices 105, 110, 115 and 120 may be part of the system of FIG. 1 without departing from the spirit and scope of the present disclosure.

### Exemplary Communication Device

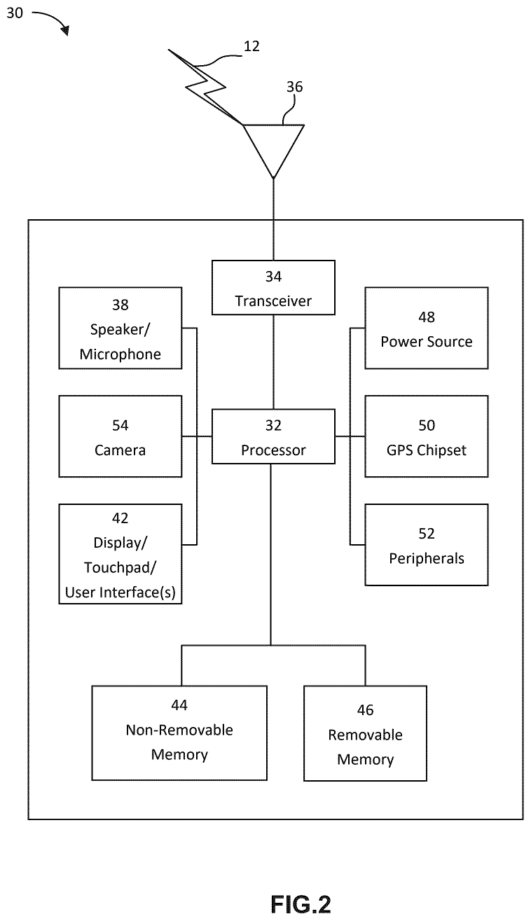

FIG. 2 illustrates a block diagram of an exemplary hardware/software architecture of a communication device such as, for example, user equipment (UE) 30. In some exemplary respects, the UE 30 may be any of communication devices 105, 110, 115, 120. In some exemplary aspects, the UE 30 may be a computer system such as, for example, a desktop computer, notebook or laptop computer, netbook, a tablet computer (e.g., a smart tablet), e-book reader, GPS device, camera, personal digital assistant, handheld electronic device, cellular telephone, smartphone, smart glasses, augmented/virtual reality device, smart watch, charging case, or any other suitable electronic device. As shown in FIG. 2, the UE 30 (also referred to herein as node 30) may include a processor 32, non-removable memory 44, removable memory 46, a speaker/microphone 38, a display, touchpad, and/or user interface(s) 42, a power source 48, a GPS chipset 50, and other peripherals 52. In some exemplary aspects, the display, touchpad, and/or user interface(s) 42 may be referred to herein as display/touchpad/user interface(s) 42. The display/touchpad/user interface(s) 42 may include a user interface capable of presenting one or more content items (e.g., graphical user interface elements) and/or capturing input of one or more user interactions/actions associated with the user interface. The power source 48 may be capable of receiving electric power for supplying electric power to the UE 30. For example, the power source 48 may include an alternating current to direct current (AC-to-DC) converter allowing the power source 48 to be connected/plugged to an AC electrical receptacle and/or Universal Serial Bus (USB) port for receiving electric power. The UE 30 may also include a camera 54. In an exemplary embodiment, the camera 54 may be a smart camera configured to sense images/video appearing within one or more bounding boxes. The UE 30 may also include communication circuitry, such as a transceiver 34 and a transmit/receive element 36. It will be appreciated that the UE 30 may include any sub-combination of the foregoing elements while remaining consistent with an embodiment.

The processor 32 may be a special purpose processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. In general, the processor 32 may execute computer-executable instructions stored in the memory (e.g., non-removable memory 44 and/or removable memory 46) of the node 30 in order to perform the various required functions of the node. For example, the processor 32 may perform signal coding, data processing, power control, input/output processing, and/or any other functionality that enables the node 30 to operate in a wireless or wired environment. The processor 32 may run application layer programs (e.g., browsers) and/or radio access-layer (RAN) programs and/or other communications programs. The processor 32 may also perform security operations such as authentication, security key agreement, and/or cryptographic operations, such as at the access-layer and/or application layer for example. The non-removable memory 44 and/or the removable memory 46 may be computer-readable storage mediums. For example, the non-removable memory 44 may include a non-transitory computer-readable storage medium and a transitory computer-readable storage medium.

The processor 32 is coupled to its communication circuitry (e.g., transceiver 34 and transmit/receive element 36). The processor 32, through the execution of computer-executable instructions, may control the communication circuitry in order to cause the node 30 to communicate with other nodes via the network to which it is connected.

The transmit/receive element 36 may be configured to transmit signals to, or receive signals from, other nodes or networking equipment. For example, in an exemplary embodiment, the transmit/receive element 36 may be an antenna configured to transmit and/or receive radio frequency (RF) signals. The transmit/receive element 36 may support various networks and air interfaces, such as wireless local area network (WLAN), wireless personal area network (WPAN), cellular, and the like. In yet another exemplary embodiment, the transmit/receive element 36 may be configured to transmit and/or receive both RF and light signals. It will be appreciated that the transmit/receive element 36 may be configured to transmit and/or receive any combination of wireless or wired signals.

The transceiver 34 may be configured to modulate the signals that are to be transmitted by the transmit/receive element 36 and to demodulate the signals that are received by the transmit/receive element 36. As noted above, the node 30 may have multi-mode capabilities. Thus, the transceiver 34 may include multiple transceivers for enabling the node 30 to communicate via multiple radio access technologies (RATs), such as universal terrestrial radio access (UTRA) and Institute of Electrical and Electronics Engineers (IEEE 802.11), for example.

The processor 32 may access information from, and store data in, any type of suitable memory, such as the non-removable memory 44 and/or the removable memory 46. For example, the processor 32 may store message thread context in its memory (e.g., non-removable memory 44 and/or removable memory 46). The non-removable memory 44 may include RAM, ROM, a hard disk, or any other type of memory storage device. The removable memory 46 may include a subscriber identity module (SIM) card, a memory stick, a secure digital (SD) memory card, and the like. In other exemplary embodiments, the processor 32 may access information from, and store data in, memory that is not physically located on the node 30, such as on a server or a home computer.

The processor 32 may receive power from the power source 48 and may be configured to distribute and/or control the power to the other components in the node 30. The power source 48 may be any suitable device for powering the node 30. For example, the power source 48 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like. The processor 32 may also be coupled to the GPS chipset 50, which may be configured to provide location information (e.g., longitude and latitude) regarding the current location of the node 30. It will be appreciated that the node 30 may acquire location information by way of any suitable location-determination method while remaining consistent with an exemplary embodiment.

### Exemplary Computing System

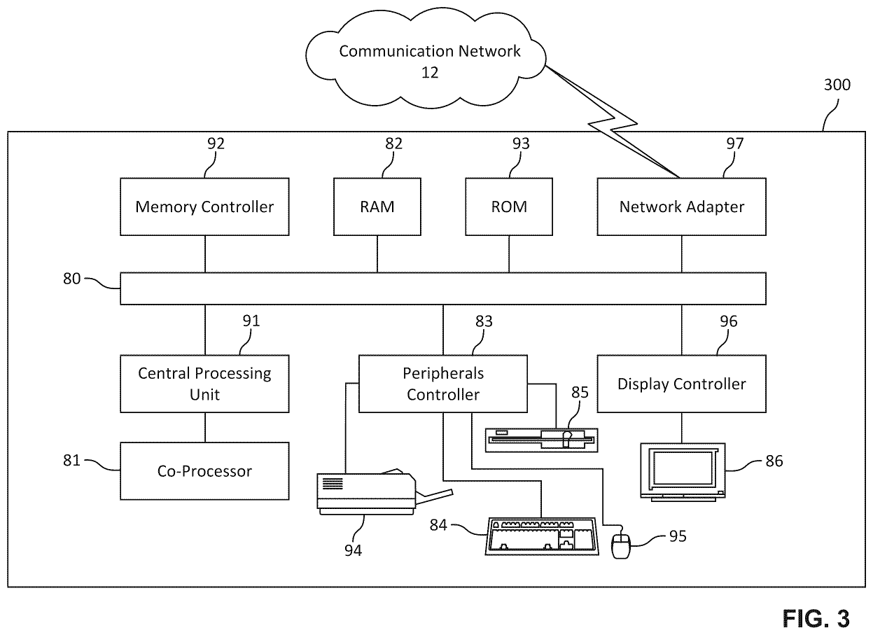

FIG. 3 is a block diagram of an exemplary computing system 300. In some exemplary embodiments, the network device 160 may be a computing system 300. The computing system 300 may comprise a computer or server and may be controlled primarily by computer-readable instructions, which may be in the form of software, wherever, or by whatever means such software is stored or accessed. Such computer-readable instructions may be executed within a processor, such as central processing unit (CPU) 91, to cause computing system 300 to operate. In many workstations, servers, and personal computers, central processing unit 91 may be implemented by a single-chip CPU called a microprocessor. In other machines, the central processing unit 91 may comprise multiple processors. Coprocessor 81 may be an optional processor, distinct from main CPU 91, that performs additional functions or assists CPU 91.

In operation, CPU 91 fetches, decodes, and executes instructions, and transfers information to and from other resources via the computer's main data-transfer path, system bus 80. Such a system bus connects the components in computing system 300 and defines the medium for data exchange. System bus 80 typically includes data lines for sending data, address lines for sending addresses, and control lines for sending interrupts and for operating the system bus. An example of such a system bus 80 is the Peripheral Component Interconnect (PCI) bus.

Memories coupled to system bus 80 include RAM 82 and ROM 93. Such memories may include circuitry that allows information to be stored and retrieved. ROMs 93 generally contain stored data that may not easily be modified. Data stored in RAM 82 may be read or changed by CPU 91 or other hardware devices. Access to RAM 82 and/or ROM 93 may be controlled by memory controller 92. Memory controller 92 may provide an address translation function that translates virtual addresses into physical addresses as instructions are executed. Memory controller 92 may also provide a memory protection function that isolates processes within the system and isolates system processes from user processes. Thus, a program running in a first mode may access only memory mapped by its own process virtual address space; it may not access memory within another process's virtual address space unless memory sharing between the processes has been set up.

In addition, computing system 300 may contain peripherals controller 83 responsible for communicating instructions from CPU 91 to peripherals, such as printer 94, keyboard 84, mouse 95, and disk drive 85.

Display 86, which is controlled by display controller 96, may be used to display visual output generated by computing system 300. Such visual output may include text, graphics, animated graphics, and video. The display 86 may also include or be associated with a user interface. The user interface may be capable of presenting one or more content items and/or capturing input of one or more user interactions associated with the user interface. Display 86 may be implemented with a cathode-ray tube (CRT)-based video display, a liquid-crystal display (LCD)-based flat-panel display, gas plasma-based flat-panel display, or a touch-panel. Display controller 96 includes electronic components required to generate a video signal that is sent to display 86.

Further, computing system 300 may contain communication circuitry, such as for example a network adapter 97, that may be used to connect computing system 300 to an external communications network, such as network 12 of FIG. 2, to enable the computing system 300 to communicate with other nodes (e.g., UE 30) of the network.

### Exemplary Machine Learning Model

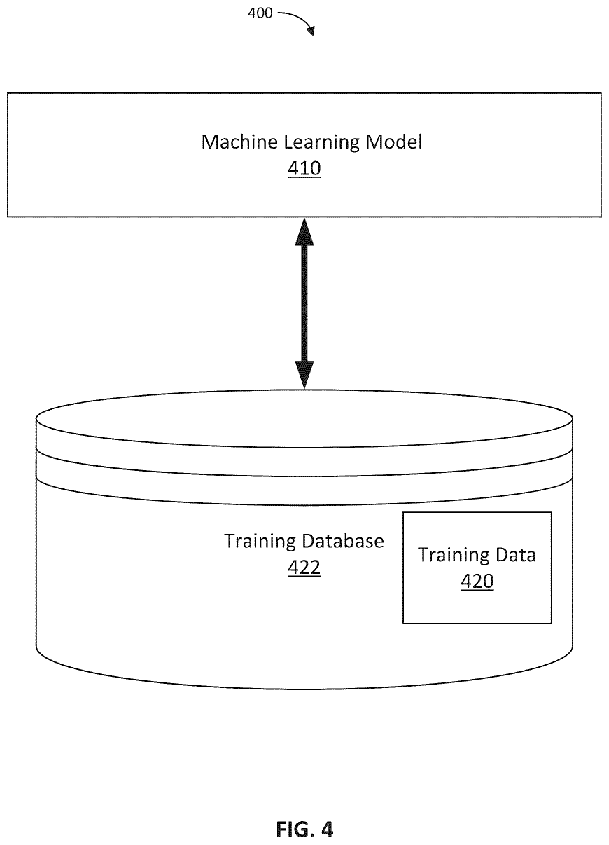

FIG. 4 illustrates a machine learning model 410 and training database 422 for training the machine learning model 410, in accordance with an example of the present disclosure. The machine learning framework 400 associated with the machine learning model 410 may be hosted remotely. Alternatively, the machine learning framework 400 may reside within a server 162 shown in FIG. 1, or be processed by an electronic device (e.g., head mounted displays, smartphones, tablets, smartwatches, or any electronic device, such as communication device 105).

The machine learning model 410 may be an algorithmic construct designed to learn patterns and/or make predictions or decisions based on data (e.g., training data 420). The machine learning model 410 may include a function that takes input variables and produces scores, predictions, classifications, and/or the like. The structure of the machine learning model 410 may include an input layer, model parameters or weights, and an output layer. The input layer may receive the data that the machine learning model 410 uses for training and/or inference. This data may be structured, such as tabular data with defined features, or unstructured, such as text, images, or time series data.

The input layer may transform the raw data into a format that the machine learning model 410 may process. The parameters or weights of the machine learning model 410 may be internal variables that may be adjusted during a training process. The weights may determine how the machine learning model 410 interprets the input data and may be responsible for the ability of the machine learning model 410 to generalize patterns and relationships. The training algorithm may adjust the weights based on the provided training data 420 and an optimization algorithm, such as gradient descent, to minimize the difference between predicted outputs and actual outputs. The output layer may produce the predictions or classifications of the machine learning model 410. The output layer may apply the learned weights to the input data to generate a result. For example, in a binary classification problem, the output layer might produce a probability value between 0 and 1, indicating the likelihood of a positive outcome. The structure of the output layer may depend on the specific problem and may vary in complexity, from a single node for simple regression problems to multiple nodes for multi-class classification tasks.

Machine learning models 410 may be broadly categorized into supervised learning, unsupervised learning, and reinforcement learning. Supervised learning models may learn from labeled examples, aiming to predict correct outputs for new, unseen data. Unsupervised learning models, may identify patterns and relationships in data without predefined labels, often used for clustering or dimensionality reduction. Reinforcement learning models may learn through trial and error, interacting with their environment and receiving feedback in the form of rewards or penalties to optimize their behavior.

The machine learning model 410 may be communicatively coupled to the stored training data 420 in a memory or database (e.g., ROM, RAM), such as training database 422 (e.g., in data store 164). The machine learning model 410 may be implemented by one or more machine learning models(s) and/or another device (e.g., a server and/or a computing system). In some embodiments, the machine learning model 410 may be a student model trained by a teacher model, and the teacher model may be included in the training database 422.

The machine learning model 410 may be implemented as one or more convolutional neural networks, recurrent neural networks, autoencoders, generative adversarial networks, transformers, diffusion models, and/or the like.

In some embodiments, machine learning model 410 may perform natural language processing (NLP) by applying various machine learning techniques to learn from large amounts of natural language data, such as text, speech, or images. Machine learning model 410 may use supervised, unsupervised, or reinforcement learning methods to train on natural language data and learn to perform NLP tasks, such as intent recognition. For example, machine learning model 410 may use convolutional neural networks to extract features from images and generate captions in natural language. Machine learning model 410 may also use recurrent neural networks to model the sequential nature of natural language and generate sentences or paragraphs. Machine learning model 410 may further use generative adversarial networks to create realistic and diverse natural language texts. Machine learning model 410 may also use transformers to encode and decode natural language sequences and perform tasks such as machine translation or text summarization. Machine learning model 410 may also use diffusion models to generate natural language texts from noise by gradually refining them through a series of steps. Machine learning model 410 may thus leverage different types of neural networks and learning methods to perform natural language processing and achieve various goals, such as identifying and extracting dates and times from text messages and calls on-device.

### Exemplary System Operation

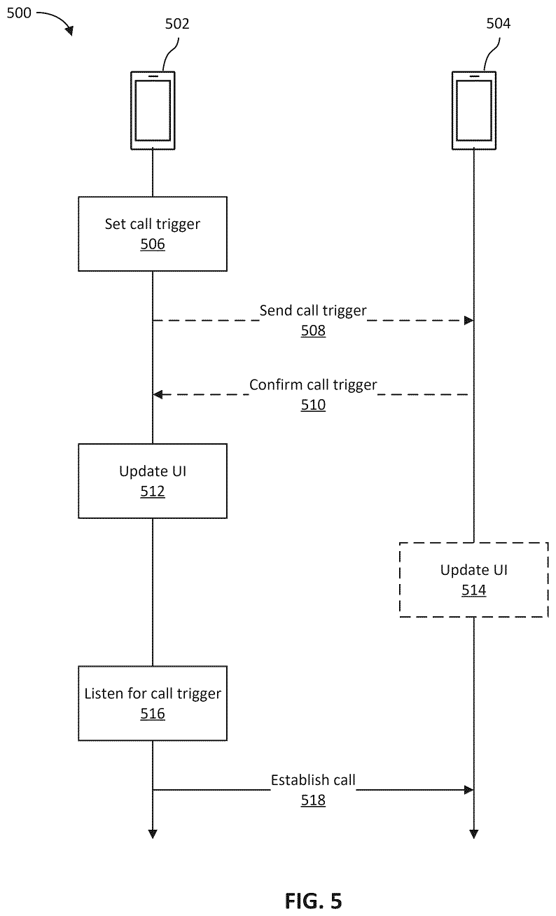

FIG. 5 illustrates an example process 500 for call scheduling between two client devices 502, 504, in accordance with one or more example aspects of the subject technology. Not all of the depicted components may be used in all implementations, however, and one or more implementations may include additional or different components than those shown in the figure. Variations in the arrangement and type of the components may be made without departing from the spirit or scope of the claims as set forth herein. Additional components, different components, or fewer components may be provided.

At block 506, the client device 502 may set a call trigger.

The client devices 502, 504 (e.g., communication devices 105, 110) may include a messaging app. The messaging app may be a comprehensive communication platform designed to facilitate seamless interactions through text messaging, audio calls, video calls, and/or the like, in one-on-one or group settings, thereby allowing users to effortlessly share text, multimedia content, files, and/or the like.

The messaging app may provide a variety of graphical user interface elements for display on the client devices 502, 504 (e.g., on display 42). One or more graphical user interface elements may be provided to display communication sessions, such as a messaging thread between client devices 502, 504. The messaging thread may enable a user (e.g., of client device 502) to send messages to other users (e.g., a user of client device 504) synchronously or asynchronously. The user interface of the messaging thread may include, for example, a message input field, a send button, and/or a message display area. The message input field may be a text box where the user may input the message, and the send button may be a clickable or touchable user interface element that, when pressed, sends the message to the intended recipient (e.g., client device 504). The message display area may be a scrolling list that displays the conversation history, including messages sent and received by the user. The messaging thread may also include and/or link to several other features, such as audio and/or video call capabilities.

Within or alongside the one or more graphical user interface elements corresponding to a communication session may be one or more graphical user interface elements that may be configured to set a call trigger to schedule a future call (e.g., an audio and/or video call). This way, a user may schedule a call directly from a messaging interface, such as a messaging thread.

For example, by long pressing (e.g., touching and holding for 2 seconds) a call button (e.g., a graphical user interface element) on the messaging thread, the user may enter a scheduling interface (e.g., another graphical user interface element). Upon activating the long press, a scheduling interface may be presented (e.g., pop-up over the messaging thread), showing the user options to select the date and time for the call. The scheduling interface may include a calendar view for date selection and a time picker for setting the specific hour and minute. The messaging app may also leverage user profile data, such as time zones and active hours, to suggest optimal call times, making the scheduling process faster and more convenient.

In addition to or instead of the long press, the messaging app may include contextual triggers within the messaging thread. The messaging app may detect (e.g., with machine learning model 410) phrases indicating an intent to schedule a call, like “Let's chat tomorrow at 3 p.m.,” and automatically highlight such phrases, providing a clickable link to schedule the call at the mentioned time (e.g., “tomorrow at 3 p.m.”). Additionally or alternatively, the messaging thread may include a dedicated scheduling button in the user interface, prominently placed for easy access. The scheduling button may cause the messaging app to render a similar scheduling interface without the need for a long press. Additionally or alternatively, the messaging app may utilize voice commands for scheduling to provide a hands-free option.

To help the scheduling process be considerate of both parties' availabilities and time zone conveniences, the messaging app may include smart features that leverage user profiles (e.g., associated with the messaging app). When a user initiates call scheduling, the messaging app may automatically pull the relevant time zone information for the initiator and/or the recipient from their respective user profiles. Time zone information may allow the messaging app to display suggested times that are mutually convenient, taking into account the overlap in active hours for each user. For instance, if one user is in New York and the other in Tokyo, the app could suggest late evening hours in New York, which correspond to morning hours in Tokyo, thus suggesting feasible times for both parties.

Additionally or alternatively, the messaging app may integrate with the users' calendars (with their permission) to access their availability data (e.g., when they are not busy). Such integration may enable the messaging app to suggest times when both users are free, thus avoiding conflicts with existing commitments. The scheduling interface may display available time slots in a distinct color or with markings, making it easy for the scheduling user to choose an appropriate time without the need to switch between apps or manually check their calendar. In some embodiments, the messaging app could employ machine learning algorithms to learn users' preferences and/or scheduling patterns over time, suggesting optimal times for calls based on historical data.

Additionally or alternatively, the messaging app may allow users to set their preferred call times, which the app may then try to match with the availability of the other party. The messaging app may also allow users to set priority levels for calls, with the messaging app dynamically suggesting rescheduling less important engagements if a high-priority call needs to be accommodated. Such dynamic scheduling may add a layer of intelligence to the messaging app, making it a more proactive tool in managing the user's communication schedule.

Although the call trigger has thus far been described as a time-based trigger, other call triggers are contemplated. Beyond date and time triggers, the messaging app may utilize a variety of other triggers to schedule calls. For example, other call triggers may include location-based, event-based, or behavioral triggers.

With location-based triggers, the messaging app may initiate a call when a user, for example, arrives at a predefined geographic location, such as home or office. This may be useful for professionals who may prefer to conduct certain calls from specific locations due to privacy or resource availability.

With event-based triggers, the messaging app may listen for in-app activities and may automatically suggest, or schedule calls based on such in-app activities. For example, the messaging app may include a digital calendar, and the messaging app may automatically suggest or schedule calls at the conclusion of a calendar event. In some embodiments, the messaging app may include one or more integrations with other apps and listen for activities from the integration. For example, the messaging app may integrate with a digital calendar app on the client device 502, and the messaging app may automatically suggest or schedule calls at the conclusion of a calendar event. Similarly, status triggers may be employed, where the messaging app may monitor the online availability of one or more parties and suggest a call when the parties are concurrently active.

With behavioral triggers, the messaging app may leverage patterns in the user's in-app activity. For example, if the messaging app detects that two users (e.g., of client device 502 and client device 504) often engage in calls after exchanging a threshold number of messages over a predetermined period of time, the messaging app may suggest scheduling a call the next time a similar message exchange occurs or is likely to occur.

At block 508, the call trigger may be shared with the other parties (e.g., client device 504) to the communication session (e.g., messaging thread). To share the call trigger, the user of client device 502 may select a graphical user interface element (e.g., a button or a menu item) on the messaging app that allows the user to send the call trigger to the other party. The messaging app of the client device 502 may then generate a message to the client device 504 that includes the call trigger information, such as the type of trigger, the trigger condition, and/or the suggested time slot for the call. The message may also include a confirmation request that asks the other party to accept or decline the call trigger. The message may be sent to the client device 504 via the messaging thread, and the client device 504 may display the message and the confirmation request to the user of client device 504. At block 510, the user of client device 504 may then respond to the confirmation request by selecting a graphical user interface element (e.g., a button or a menu item) on the messaging app interface that indicates their acceptance or rejection of the call trigger.

In some embodiments, the sending of the call trigger (at block 508) and/or the confirmation of the call trigger (at block 510) may be handled by the messaging application automatically in the background, without user intervention. For example, upon determining the call trigger, the client device 502 may automatically send the call trigger to the client device 504 for the user of the client device 504 to confirm. As another example, the client device 502 may automatically send the call trigger to the client device 504 for the messaging app of the client device 504 to automatically confirm the call trigger upon verifying that the call trigger conforms to user preferences stored on the client device 504.

In some embodiments, the call trigger may not be sent to the other participants via the messaging thread (e.g., client device 504). The messaging app may simply schedule a call to the other participants and may initiate it from the client device 502.

At block 512, after the call trigger has been determined, the user interface of the messaging thread may be updated to reflect the call trigger. For example, the messaging app may update the messaging thread to include an indicator (e.g., graphical user interface element, such as a message or an icon) notifying the user of the client device 502 of the status of the call trigger. For example, the messaging thread may include a messaging stating that there is a scheduled call with the participant(s) of the messaging thread. In some embodiments, if the call trigger is accepted by the parties to the messaging thread, the messaging app may also update the digital calendars of both parties with the scheduled call details (e.g., the time, time zone, the party to initiate the call, etc.). If the call trigger is declined, the messaging app may suggest another time slot or another type of trigger for scheduling the call.

During or after the messaging app updates its user interface on the client device 502, the messaging app on the client device 504 may similarly update its user interface at block 514.

At block 516, the messaging app may listen for the call trigger. Initially, when a call is scheduled within the messaging app, the details of the corresponding call trigger, such as the time and any conditions attached to the trigger, may be stored locally on the client device 502. The messaging app may include a background service that runs quietly, for example, at the application and/or operating system level. The background service may be responsible for monitoring the current time and comparing it against the scheduled call times associated with the call trigger. As the scheduled time approaches, the service may increase its checking frequency for timely execution of the call.

In addition to or instead of time-based triggers, the messaging app may also listen for other types of triggers using similar event listeners. For instance, if the trigger is location-based, the messaging app may use the GPS location service (e.g., GPS chipset 50) of the client device 502 to receive updates about the location of the client device 502 and compare it with the predefined location trigger for the call. Similarly, for activity-based triggers, the messaging app may tap into device sensors or application event APIs to detect the completion of an event.

At block 518, once the call trigger is satisfied in the messaging app, the messaging app may establish the call. For instance, when the internal clock of the client device 502 matches the time trigger for the call, or when a location-based trigger is met, the messaging app may begin the process to initiate the call. The messaging app may send a notification to each party to the call (e.g., client device 502, 504), alerting them that the call is about to begin or has already begun. The notification may include options such as “Join Call” or “Dismiss,” providing users a momentary buffer to prepare for or opt-out of the call.

The messaging app may also activate its call function. The user interface for the parties to the call may transition to the call screen, displaying relevant details for the call, such as the caller's name and any scheduled call notes. The messaging app may then attempt to establish a connection (e.g., to one or more other parties to the call) using the networking service (e.g., transceiver 34) of the respective device, whether through Wi-Fi or cellular data, to handle the voice or video call data transfer.

In some embodiments, rather than automatically initiating the call, the messaging app may offer a virtual waiting room where users may confirm their readiness before the call officially begins (e.g., before the user enters the call).

In some embodiments, when one or more parties to the call have not joined the call, the messaging app may inject audio into the call including a tone or message to indicate that the other participant has not accepted the call yet and may join the call momentarily.

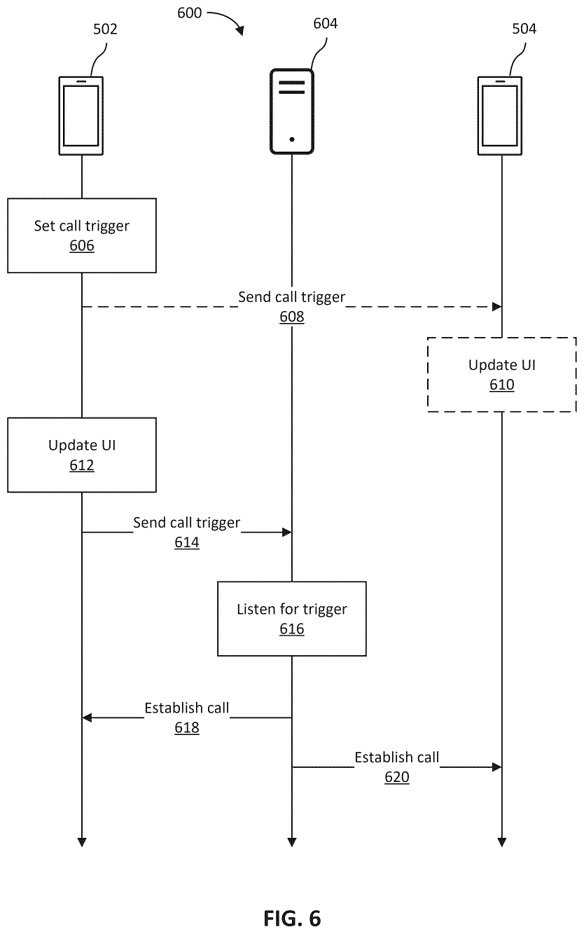

FIG. 6 illustrates an example process 600 for call scheduling between two client devices 502, 504 facilitated by a server device 604, in accordance with one or more example aspects of the subject technology. Not all of the depicted components may be used in all implementations, however, and one or more implementations may include additional or different components than those shown in the figure. Variations in the arrangement and type of the components may be made without departing from the spirit or scope of the claims as set forth herein. Additional components, different components, or fewer components may be provided.

In addition to or instead of scheduling the call and establishing the call in-app, the messaging app may utilize one or more remote servers (e.g., server device 604). The server device 604 may be a network device 160 and/or a computing system 300.

Setting the call trigger at block 606 may be performed in a manner similar to block 506, described above. The call trigger may optionally be sent to the client device 504 at block 608 so that the client device 504 may confirm and update its user interface at block 610. Likewise, updating the user interface at block 612 may be performed in a manner similar to block 512, described above.

At block 614, the client device 502 may send the call trigger to the server device 604. Utilizing the server device 604 may offer several advantages that enhance functionality, scalability, and/or user experience of the in-app call scheduling process 600. For example, involving a server device 604 in the scheduling process allows for centralized management of call schedules, which may be beneficial for users who access the messaging app from multiple devices (e.g., smartphone, tablet, and computer). Server-side scheduling may help client devices 502, 504 be synchronized with the latest call schedule. The server device 604 may have capabilities to manage large-scale data and coordination tasks more efficiently than individual devices (e.g., client devices 502, 504) could, especially when handling multiple participants, complex scheduling, or sophisticated call features like encryption and live transcription.

In terms of listening for call triggers at block 616, while most if not all of the listening may be handled on-device at client device 502, the server device 604 may assist in aggregating and processing non-sensitive metadata to optimize the timing of notifications and/or to handle complex scheduling scenarios involving multiple participants (e.g., across different time zones). For instance, the server device 604 may calculate the optimal call time for group calls and push this information to each participant's device (e.g., client device 502, 504).

At blocks 618 and 620, for direct call initiation, the server device 604 may act as an intermediary that initiates outbound connections to each participant's device (e.g., client devices 502, 504) in response to the trigger being satisfied (e.g., at the scheduled time). In this approach, the server device 604 may call each participant so that everyone is brought into the call simultaneously or near simultaneously. This may be useful for helping calls start on time and verifying that all participants are connected. For example, in a group call scenario, the server device 604 may handle the complexities of connecting multiple users from various locations, managing different connection speeds and hardware capabilities, ensuring a smoother start and fewer user-side errors.

Alternatively, the server device 604 may send a signal to one or more devices (e.g., client device 502), prompting them to start the call and call the other participating devices. In this approach, the server device 604 does not directly make the call but sends a notification or a command to the client device 502, which then initiates the call itself. This approach may leverage the ability of the server device 604 to monitor the satisfaction of the trigger condition while utilizing the capabilities of the client device 502 to handle the actual call setup. This approach may be beneficial because it may dynamically adjust to the readiness of the participants, allowing for features like delaying the call start if a participant is not ready or offering the ability to manually join a pre-initiated call.

When it comes to initiating calls, leveraging the server device 604 may improve the reliability and quality of the call connection. The server device 604 may manage the signaling processes required to establish a connection between client devices 502, 504, including negotiating the media types and parameters for the call. This is useful for handling voice and video traffic efficiently, especially in cases where direct peer-to-peer connection is not feasible, for example, due to firewall restrictions. Additionally, the server device 604 may monitor call quality in real-time and make adjustments as needed, such as switching between different servers or routes to minimize latency and maximize call clarity.

Furthermore, using the server device 604 may allow for the implementation of additional features such as call recording, real-time translation, and advanced analytics, which may require substantial processing power and storage resources that are more scalable on servers than on individual client devices. This central handling may make it easier to maintain and update the calling service so that all users may benefit from the latest features and improvements without the need for frequent client-side updates.

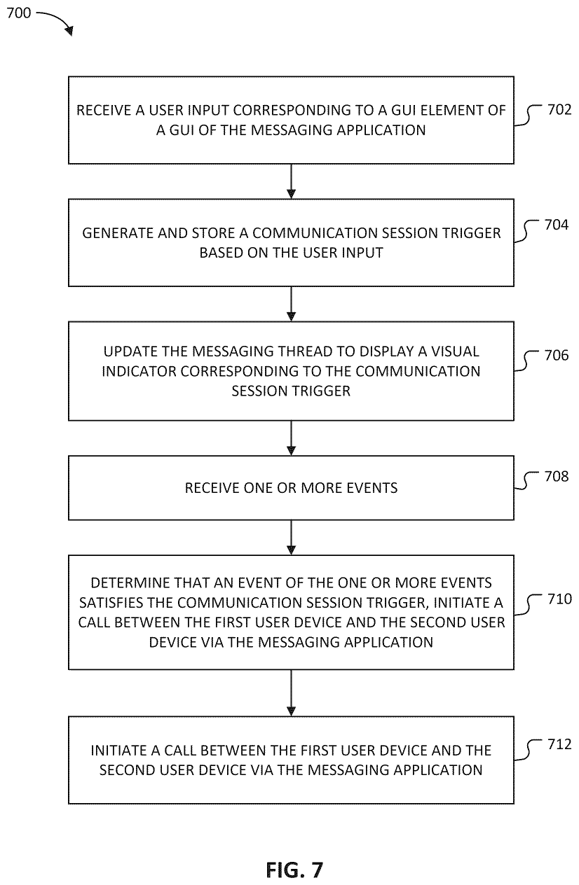

FIG. 7 illustrates a flow diagram of an example process 700 for communication session scheduling between two client devices (e.g., client devices 502, 504), in accordance with one or more example aspects of the subject technology. For explanatory purposes, the process 700 is primarily described herein with reference to the client devices 502, 504 of FIGS. 5-6. However, the process 700 is not limited to such devices, and one or more blocks of the process 700 may be performed by one or more other suitable devices. Further, for explanatory purposes, the blocks of the process 700 are described herein as occurring sequentially or linearly. However, multiple blocks of the process 700 may occur in parallel. In addition, the blocks of the process 700 need not be performed in the order shown and/or one or more blocks of the process 700 need not be performed and/or may be replaced by other operations.

The process 700 may be performed by a messaging application running on the client device 502. The messaging application may include software instructions that, when executed by the client device 502 (e.g., the processor 32), may cause the client device 502 to perform the actions of the process 700. Accordingly, for discussion purposes, the messaging application may be said to have performed such actions.

The messaging application may be configured to trigger and/or host one or more communication sessions. A communication session, as discussed herein, may refer to any instance of interactive digital communication that may involve various formats, such as audio calls, video calls, metaverse calls, and/or the like, and encompasses the diverse ways users may connect and interact in a digital environment. For case of discussion, the subject technology may be described herein with respect to audio and/or video calls. However, communication sessions are not limited to audio and/or video calls, and other forms of interactive communication are contemplated.

At block 702, the messaging application running on the client device 502 may receive a user input corresponding to a graphical user interface (GUI) element of a GUI of the messaging application. The messaging application may include one or more messaging threads, each corresponding to a different messaging session. For example, the messaging application may include messaging thread between a friend and a separate messaging thread between the same friend and another person. The messaging application may include one or more GUIs for each messaging thread. The GUIs may each include one or more GUI elements (e.g., visual components), such as icons and other visual elements, for displaying and/or receiving information.

The GUI of a messaging thread may include GUI elements that include the identity of the participants of the messaging thread, an area to view messages exchanged between the participants, an area to input messages to be sent to the participants, and the like. The GUI of a messaging thread may also include GUI elements corresponding to one or more actions that may be performed relating to the participants of the messaging thread, such as a calling element to initiate a call with the participants.

In some embodiments, the GUI element for receiving user input includes a scheduling interface. The scheduling interface may include one or more input elements for the user to input a date, time, and/or any other parameters for triggering the initiation of a communication session, such as a voice and/or video call. The scheduling interface may be part of the GUI of the messaging thread, a pop-up or overlay over the messaging thread, a separate GUI, or any other GUI that is associated with the messaging thread (e.g., returns to the messaging thread after input is provided).

In some embodiments, the GUI element for receiving user input may be provided in response to a long press of a GUI element of the GUI of the messaging thread. For example, the messaging thread may include a telephone icon, indicating an action to start a call with the participants of the messaging thread. A long press (e.g., 2 seconds) of the telephone icon may cause the scheduling interface, or any other user input, to appear to schedule a call. In some embodiments, a long press may direct the messaging application to automatically schedule a communication session, such as a call.

In some embodiments, the GUI element for receiving user input may include at least part of one or more messages in the messaging thread. The messaging application may identify a user intent to schedule a communication session, time and dates, locations, and/or any other indications of a communication session trigger within messages exchanged in the messaging thread. The identification may be performed by a machine learning model (e.g., machine learning model 410) on the client device 502 configured to perform NLP. The identified portions of the messages may be displayed as links or icons that, when interacted with by the user, may cause the scheduling interface to be displayed pre-filled with the identified trigger parameters or automatically schedule a communication session corresponding to the identified trigger parameters.

For example, a message may include “Good morning. Can you call me sometime today?” The messaging application may underline “today,” indicating that the user may select the word to schedule a communication session for that day. The scheduling interface may be pre-filled with that day and, in some embodiments, may also be pre-filled with a suggested time that day that the participants are available in their respective time zones.

At block 704, the messaging application may generate and store a communication session trigger based on the user input. The user input may include the parameters of the communication session trigger, such as date, time, location, and/or the like.

In some embodiments, the messaging application may automatically infer one or more parameters of the communication session trigger according to one or more messages in the messaging thread (e.g., times mentioned in a message) and/or preferences (e.g., preferred times), statuses (e.g., active or away), schedules (e.g., participants who have their schedule integrated with the messaging application), locations (e.g., GPS locations provided by the device running the messaging application), time zones, and/or the like of one or more participants.

At block 706, the messaging application may update the messaging thread to display a visual indicator corresponding to the communication session trigger. The visual indicator may be an icon or any other visual effect to indicate in the messaging thread that a communication session has been scheduled. The visual indicator may also or instead be a message describing one or more parameters of the communication session trigger. For example, the messaging thread may include a message saying, “a video call is scheduled for tomorrow at 6 p.m.”

At block 708, the messaging application may receive one or more events. The events may be received by internal monitoring and/or external signals, depending on the event type. For time-based events, for example, the messaging app may periodically receive the time from the internal clock of the client device 502. For location and/or activity-based events, for example, the messaging app may receive information (e.g., location information) from the sensors (e.g., GPS chipset 50) of the client device 502. For events like changes in user status or calendar events, for example, the messaging application may be subscribed to one or more APIs (e.g., a calendar application API) that provides (e.g., pushes) information to the messaging application.

At block 710, the messaging application may determine that an event satisfies the communication session trigger. The messaging application may compare the event and/or one or more parameters thereof to the communication session trigger. For example, the messaging application may compare the current time to the scheduled time to determine whether current time matches or passed the scheduled time.

At block 712, when the messaging application determines that an event satisfies the communication session trigger, the messaging application may initiate a communication session between the client device 502 and the client device 504. The messaging application may host the communication session and may be responsible for notifying the client device 502 and the client device 504 of the communication session. For example, the messaging application may display on the client device 502 an interface representing an incoming communication session, and the interface may include GUI elements to accept or dismiss the communication session.

In some embodiments, the messaging application may also manage the user experience during the communication session. For example, the messaging application may include a virtual waiting room for one or more participants to prepare for the communication session (e.g., to test audio levels) before joining the communication session. As another example, if some but not all participants have joined the communication session, the messaging application may play an audio indicating to the participants on the communication session that some participants have not yet joined the communication session.

### Alternative Embodiments

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Some portions of this description describe the embodiments in terms of applications and symbolic representations of operations on information. These application descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as components, without loss of generality. The described operations and their associated components may be embodied in software, firmware, hardware, or any combinations thereof.

Any of the steps, operations, or processes described herein may be performed or implemented with one or more hardware or software components, alone or in combination with other devices. In one embodiment, a software component is implemented with a computer program product comprising a computer-readable medium containing computer program code, which can be executed by a computer processor for performing any or all of the steps, operations, or processes described.

Embodiments also may relate to an apparatus for performing the operations herein. This apparatus may be specially constructed for the required purposes, and/or it may comprise a computing device selectively activated or reconfigured by a computer program stored in the computer. Such a computer program may be stored in a non-transitory, tangible computer-readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments also may relate to a product that is produced by a computing process described herein. Such a product may comprise information resulting from a computing process, where the information is stored on a non-transitory, tangible computer-readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

What is claimed:

1. A method comprising:
receiving, by a messaging application running on a first user device, a user input corresponding to a graphical user interface element of a graphical user interface of the messaging application, wherein the graphical user interface element is displayed in association with a messaging thread of the messaging application and the messaging thread includes one or more messages between the first user device and a second user device;
generating and storing, by the messaging application, a communication session trigger based on the user input;
updating, by the messaging application, the messaging thread to display a visual indicator corresponding to the communication session trigger;
receiving, by the messaging application, one or more events;
determining, by the messaging application, that an event of the one or more events satisfies the communication session trigger; and
initiating, by the messaging application and based on the determination, a communication session between the first user device and the second user device via the messaging application.

2. The method of claim 1, wherein the graphical user interface element for receiving the user input is presented in response to a long press of another graphical user interface element of the graphical user interface.

3. The method of claim 1, wherein the graphical user interface element includes at least part of one or more messages in the messaging thread identified by the messaging application based on one or more natural language processing processes.

4. The method of claim 1, wherein the communication session trigger is based on any one or more of time or location.

5. The method of claim 1, wherein the communication session trigger is automatically generated based on a comparison between any one or more of time zones, schedules, active statuses, or user preferences of the first user device and the second user device.

6. The method of claim 1, wherein initiating the communication session comprises:
displaying, by the messaging application and on the first user device, another graphical user interface including a graphical user interface element to accept the communication session and a graphical user interface element to dismiss the communication session; and
in response to another user input corresponding to the other graphical user interface element to accept the communication session, initiating the communication session between the first user device and the second user device via the messaging application.

7. The method of claim 1, further comprising:
in response to the first user device joining the communication session when the second user device has not joined the communication session, providing, by the messaging application, an audio signal indicating that the second user device has not joined the communication session.

8. A device comprising:
at least one processor; and
at least one memory storing instructions that, when executed by the at least one processor, cause the at least one processor to:
receive, by a messaging application running on the device, a user input corresponding to a graphical user interface element of a graphical user interface of the messaging application, wherein the graphical user interface element is displayed in association with a messaging thread of the messaging application and the messaging thread includes one or more messages between the device and another device;
generate and store, by the messaging application, a communication session trigger based on the user input;
update, by the messaging application, the messaging thread to display a visual indicator corresponding to the communication session trigger;
receive, by the messaging application, one or more events;
determine, by the messaging application, that an event of the one or more events satisfies the communication session trigger; and
initiate, by the messaging application and based on the determination, a communication session between the device and the other device via the messaging application.

9. The device of claim 8, wherein the graphical user interface element for receiving the user input is presented in response to a long press of another graphical user interface element of the graphical user interface.

10. The device of claim 8, wherein the graphical user interface element includes at least part of one or more messages in the messaging thread identified by the messaging application based on one or more natural language processing processes.

11. The device of claim 8, wherein the communication session trigger is based on any one or more of time or location.

12. The device of claim 8, wherein the communication session trigger is automatically generated based on a comparison between any one or more of time zones, schedules, active statuses, or user preferences of the device and the other device.

13. The device of claim 8, wherein initiating the communication session comprises:
displaying, by the messaging application and on the device, another graphical user interface including a graphical user interface element to accept the communication session and a graphical user interface element to dismiss the communication session; and
in response to another user input corresponding to the other graphical user interface element to accept the communication session, initiating the communication session between the device and the other device via the messaging application.

14. The device of claim 8, further comprising:
in response to the device joining the communication session when the other device has not joined the communication session, providing, by the messaging application, an audio signal indicating that the other device has not joined the communication session.

15. A non-transitory computer-readable medium storing instructions that, when executed by a processor of a first user device, causes the processor to perform operations comprising:
receiving, by a messaging application running on the first user device, a user input corresponding to a graphical user interface element of a graphical user interface of the messaging application, wherein the graphical user interface element is displayed in association with a messaging thread of the messaging application and the messaging thread includes one or more messages between the first user device and a second user device;
generating and storing, by the messaging application, a communication session trigger based on the user input;
updating, by the messaging application, the messaging thread to display a visual indicator corresponding to the communication session trigger;
receiving, by the messaging application, one or more events;
determining, by the messaging application, that an event of the one or more events satisfies the communication session trigger; and
initiating, by the messaging application and based on the determination, a communication session between the first user device and the second user device via the messaging application.

16. The non-transitory computer-readable medium of claim 15, wherein the graphical user interface element for receiving the user input is presented in response to a long press of another graphical user interface element of the graphical user interface.

17. The non-transitory computer-readable medium of claim 15, wherein the graphical user interface element includes at least part of one or more messages in the messaging thread identified by the messaging application based on one or more natural language processing processes.

18. The non-transitory computer-readable medium of claim 15, wherein the communication session trigger is based on any one or more of time or location.

19. The non-transitory computer-readable medium of claim 15, wherein the communication session trigger is automatically generated based on a comparison between any one or more of time zones, schedules, active statuses, or user preferences of the first user device and the second user device.

20. The non-transitory computer-readable medium of claim 15, wherein initiating the communication session comprises:
displaying, by the messaging application and on the first user device, another graphical user interface including a graphical user interface element to accept the communication session and a graphical user interface element to dismiss the communication session; and
in response to another user input corresponding to the other graphical user interface element to accept the communication session, initiating the communication session between the first user device and the second user device via the messaging application.
